(19) United States
(12) Patent Application Publication
(10) Pub. No.: US 2025/0239761 A1
(43) Pub. Date: Jul. 24, 2025

(54) POSITIONING DEVICE

(71) Applicant: ALPS ALPINE CO., LTD., Tokyo (JP)

(72) Inventors: Taiki IGARASHI, Miyagi (JP); Daisuke TAKAI, Tokyo (JP)

(21) Appl. No.: 19/174,225

(22) Filed: Apr. 9, 2025

Related U.S. Application Data
(63) Continuation of application No. PCT/JP2023/031028, filed on Aug. 28, 2023.

(30) Foreign Application Priority Data
Oct. 27, 2022 (JP) 2022-172420

(51) Int. Cl. H01Q 3/26; G01S 5/06

(52) U.S. Cl. CPC H01Q 3/2652; G01S 5/06

(57) ABSTRACT

A positioning device includes: an antenna part with N antenna elements forming a plurality of pairs of antenna elements, N being an integer greater than or equal to three; a selection part configured to select a pair of antenna elements whose phase shift quality is higher than or equal to a predetermined level, based on a phase shift observed between phases of a signal received by respective antenna elements in a pair when each of the plurality of pairs receives the signal from a positioning target device; and a distance measurement part configured to measure a distance between the positioning target device and the antenna part based on phases of signals communicated between the positioning target device and one antenna element included in the pair selected by the selection part.

### CROSS-REFERENCE TO RELATED APPLICATIONS

This application is a continuation application of International Application No. PCT/JP2023/031028, filed on Aug. 28, 2023, and designated the U.S., which is based upon and claims priority to Japanese Patent Application No. 2022-172420, filed on Oct. 27, 2022. The entire contents of these applications are incorporated herein by reference.

### BACKGROUND OF THE INVENTION

### 1. Field of the Invention

The present disclosure relates to a positioning device.

### 2. Description of the Related Art

A positioning device heretofore: transmits signals to a target object; receives, using two antennas, composite waves comprised of direct-path reflected waves (or transmitted signals that are reflected by a reflector and directly return to the antennas) and multi-path reflected waves (or transmitted signals that are reflected by the reflector, reflected again by other reflecting surfaces, and then return to the antennas) as received signals; and calculates (measures) the distance to the target object based on quadrature baseband signals detected from the received signals by quadrature detection. To be more specific, signals of multiple frequencies are transmitted first, and the distance to the target object is calculated based on the relationship between: the differences between the multiple transmitting frequencies; and the roundtrip phase shifts between transmitted signals and received signals per frequency (see, for example, patent document 1).

### CITATION LIST

### Patent Document

[Patent Document 1] Unexamined Japanese Patent Application Publication No. 2011-012984

### SUMMARY OF THE INVENTION

According to an embodiment of the present disclosure, a positioning device includes: an antenna part with N antenna elements from which combinations of two antenna elements are selected to form a plurality of pairs, N being an integer greater than or equal to three; a selection part configured to select a pair of antenna elements whose phase shift quality is higher than or equal to a predetermined level, based on a phase shift observed between phases of a signal received by respective antenna elements in a pair when each of the plurality of pairs receives the signal from a positioning target device; and a distance measurement part configured to measure a distance between the positioning target device and the antenna part based on phases of signals communicated between the positioning target device and one antenna element included in the pair of antenna elements selected by the selection part. The selection part is configured to determine, for each of the plurality of pairs, a standard deviation of phase shifts, each of which is observed between phases of a corresponding one of a plurality of signals having respective frequencies received from the positioning target device, and the selected pair of antenna elements is a pair whose standard deviation has a quality higher than or equal to a predetermined level. The signals having respective frequencies are signals having different frequencies.

### BRIEF DESCRIPTION OF THE DRAWINGS

FIG. 1 is a diagram showing an example structure of a positioning device 100 according to an embodiment of the present disclosure;

FIG. 2 is a diagram showing an example structure of an antenna device 110 included in the positioning device 100;

FIG. 3 is a diagram showing examples of phase shifts and standard deviations at multiple frequencies; and

FIG. 4 is a flowchart showing examples of steps to be executed by a control device of a positioning device.

### DETAILED DESCRIPTION OF THE PREFERRED EMBODIMENTS

A positioning device with multiple antennas such as the one described above measures the distance to a target object, by using multiple antennas, based on the relationship between: differences among multiple frequencies; and the roundtrip phase shifts between transmitted signals and received signals per frequency, thereby allowing a highly accurate distance measurement result to be selected. However, measuring the distance to a target object by determining the roundtrip phase shift at each of multiple frequencies, at all of multiple antennas, is time-consuming.

The present disclosure therefore aims to provide a positioning device that can quickly calculate a highly-accurate distance measurement result.

A positioning device according to an embodiment of the present disclosure will be described below.

### Embodiment

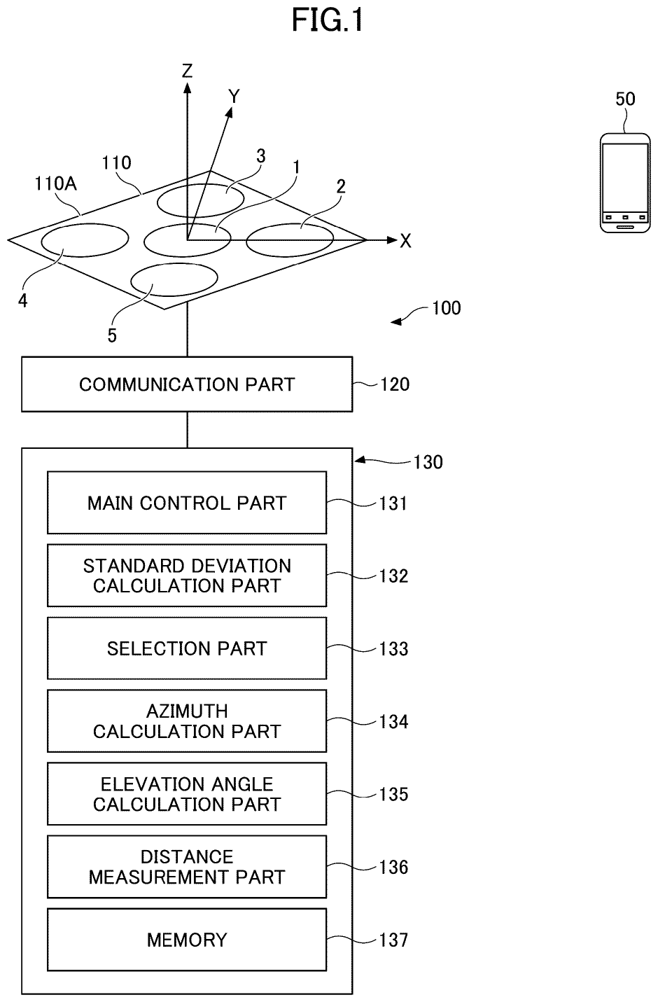

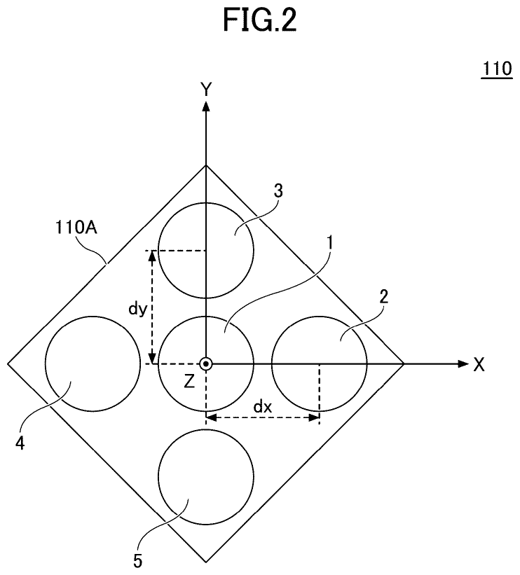

FIG. 1 is a diagram showing an example structure of a positioning device 100 according to an embodiment. FIG. 2 is a diagram showing an example structure of an antenna device 110 included in the positioning device 100. The following description will be given using the XYZ coordinate system. The X axis is an example of a first axis, the Y axis is an example of a second axis, and the Z axis is an example of a third axis.

FIG. 1 shows a smartphone 50 in addition to the positioning device 100. The smartphone 50 is an example of a positioning target device. The positioning device 100 receives signals transmitted from the smartphone 50, determines the azimuth and elevation angle of the smartphone 50 relative to the positioning device 100, and measures the distance between the positioning device 100 and the smartphone 50. Signals transmitted in both directions between the positioning device 100 and the smartphone 50 may include, for example, modulated signals obtained by modulating I/Q signals.

The positioning device 100 includes an antenna device 110, a communication part 120, and a control device 130. The antenna device 110 is an example of an antenna part. The antenna device 110 has a substrate 110A and antenna elements 1 to 5. The substrate 110A is made of an insulator. The antenna elements 1 to 5 receive modulated signals transmitted from the smartphone 50. The antenna device 110 is connected to the control device 130 via the communication part 120.

The antenna elements 1 to 5 are connected to the control device 130. For example, the antenna elements 1 to 5 may be, in a plan view, circular patch antennas provided on a +Z-side surface of the substrate 110A. The antenna elements 1 to 5 are examples of multiple antenna elements.

The substrate 110A is square in a plan view, and the antenna element 1 is positioned at the center of its top surface. In this example, the origin of the XYZ coordinate system is located at the center of a surface of the antenna element 1. The antenna element 1 is positioned at the center of four antenna elements 2 to 5 in a plan view. The antenna elements 2 and 4 are positioned such that their respective centers in a plan view are located on the X axis. The antenna element 2 is located on the +X-side with respect to the antenna element 1. The antenna element 4 is located on the −X-side with respect to the antenna element 1. The antenna elements 3 and 5 are positioned such that their respective centers in a plan view are located on the Y axis. The antenna element 3 is located on the +Y-side with respect to the antenna element 1. The antenna element 5 is located on the −Y-side with respect to the antenna element 1. The distances between the center of the antenna element 1 and the respective centers of the antenna elements 2 to 5 are all equal, and are half or less of the wavelength of the signals transmitted from the smartphone 50. Also, the interval (distance) between the antenna elements 2 and 3, the interval between the antenna elements 3 and 4, the interval between the antenna elements 4 and 5, and the interval between the antenna elements 5 and 2 are all equal and half or less of the wavelength of the signals transmitted from the smartphone 50.

The antenna element 1 is an example of a first antenna element. The antenna element 2 is an example of a second antenna element located at a predetermined distance from the antenna element 1 in the X direction. The antenna element 3 is an example of a third antenna element located at a predetermined distance from the antenna element 1 in the Y direction. The distance between the antenna element 1 and the antenna element 2 in the X direction and the distance between the antenna element 1 and the antenna element 3 in the Y direction are equal. Also, the antenna element 4 may be another example of a second antenna element located at a predetermined distance from the antenna element 1 in the X direction. The antenna element 5 may be another example of a third antenna element located at a predetermined distance from the antenna element 1 in the Y direction. The antenna device 110 has only to include at least three antenna elements. To be more specific, although the antenna device 110 has only to have an antenna element 1 as a first antenna element and have one second antenna element and one third antenna element, FIG. 1 shows an example in which five antenna elements 1 to 5 are provided. Note that the antenna device 110 may have a ground plate held at ground potential on a −Z-side surface of the substrate 110A.

Examples of the communication part 120 include a power amplifier (PA), a low noise amplifier (LNA), an orthogonal modulator (OM), an orthogonal demodulator (ODM), a voltage-controlled oscillator (VCO), a phase-locked loop (PLL), a codec processing part, etc. When the communication part 120 transmits a signal to the smartphone 50, an I/Q signal is generated in the codec processing part from a BLE packet signal input from the control device 130, converted into an analog signal through a digital-to-analog conversion (DAC) process, and output to the OM as an I/Q signal that serves as a transmission signal. The OM modulates the I/Q signal and outputs the resulting modulated signal to the PA for transmission. The transmission signal is amplified at the PA and output to the antenna device 110. Also, when the communication part 120 receives a signal from the smartphone 50, the signal received as an input by the antenna device 110 is amplified in the LNA and output to the ODM. The ODM demodulates the received signal to obtain the I/Q signal, and outputs the I/Q signal to the codec processing part. The codec processing part converts the I/Q signal processed by the ODM into a Bluetooth (registered trademark) low energy packet signal through digital conversion, and outputs it to the control device 130.

The control device 130 has a main control part 131, a standard deviation calculation part 132, a selection part 133, an azimuth calculation part 134, an elevation angle calculation part 135, a distance measurement part 136, and a memory 137.

The main control part 131, the standard deviation calculation part 132, the selection part 133, the azimuth calculation part 134, the elevation angle calculation part 135, the distance measurement part 136, and the memory 137 are implemented by a microcomputer (computer) including, for example, a central processing unit (CPU), a random access memory (RAM), a read only memory (ROM), an inner bus, etc. The main control part 131, the standard deviation calculation part 132, the selection part 133, the azimuth calculation part 134, the elevation angle calculation part 135, and the distance measurement part 136 are illustrated as functional blocks that represent the functions of programs executed by the microcomputer. Also, the memory 137 is a functional representation of the microcomputer's memory.

In order to enable the distance measurement part 136 to produce a highly accurate distance measurement result quickly, before the distance measurement part 136 calculates the distance to the smartphone 50, the positioning device 100 selects one antenna element that the distance measurement part 136 can use when measuring the distance to the smartphone 50 based on a time-of-arrival (TOA) method. When signals of four frequencies (or, interchangeably, four “channels” including a channel (or “ch”) 1, a ch2, a ch3, and a ch4) arrive at four pairs of antenna elements of the positioning device 100 from the smartphone 50, the positioning device 100 determines the standard deviation of phase shifts in each pair of antenna elements, and selects an antenna element included in the pair with the minimum standard deviation as one antenna element for use in distance measurement.

The environment in which the five antenna elements 1 to 5 of the antenna device 110 transmit and receive radio waves varies depending on the type and location of metallic objects around the antenna device 110, the type and location of objects that may serve as reflecting surfaces around the antenna device 110, the type and level of noise from the surroundings, and so on. To be more specific, the antenna elements 1 to 5 may include antenna elements that are affected significantly by multi-path, and antenna elements that are affected little or none by multi-path. The accuracy of distance measurement decreases at an antenna element on which multi-path has a significant impact. In other words, when measuring a distance, the accuracy of distance measurement can be improved by using an antenna element on which multi-path has little impact.

Also, in the event that TOA-based distance measurement is employed, to determine the roundtrip phase shift between the antenna device 110 and the smartphone 50 with respect to multiple frequencies, data that indicates the phases of signals as received by the smartphone 50 needs to be obtained from the smartphone 50. However, the method of measuring distances for all of the five antenna elements 1 to 5 and then selecting a highly accurate distance measurement result takes a long time to finish the whole process of distance measurement.

For this reason, the positioning device 100, for an example, places one antenna element 1 that serves as a reference point at the center of the antenna device 110 in a plan view, places four antenna elements 2 to 5 at equally-distanced surrounding locations from the antenna element 1, and measures the distance to the smartphone 50 by selecting one antenna element that is affected least by multi-path, from among the four antenna elements 2 to 5, as an antenna element for use in ToA-based distance measurement.

Varying frequencies may result in varying phase shifts if affected by multi-path. When signals of four frequencies arrive at the four pairs of antenna elements of the positioning device 100 from the smartphone 50, the positioning device 100 determines the standard deviation of phase shifts in each pair of antenna elements. Then, from among the two antenna elements included in the pair with the minimum standard deviation, the positioning device 100 selects the antenna element that is not the antenna element 1, as the antenna element for use in ToA-based distance measurement. In other words, the positioning device 100 evaluates the antenna elements 2 to 5 located around the antenna element 1 based on the respective standard deviations of phase shifts of the signals of four frequencies upon receipt at the four pairs of antenna elements.

Also, since the distance to the smartphone 50 is measured based on a ToA method using one antenna element that is affected little by multi-path, the distance can be measured quickly and accurately.

The main control part 131 is a control part that manages the control process by the control device 130, and performs processes other than those performed by the standard deviation calculation part 132, the selection part 133, the azimuth calculation part 134, the elevation angle calculation part 135, and the distance measurement part 136. The azimuth calculation part 134 and the elevation angle calculation part 135 are examples of angle calculation parts.

For example, the standard deviation calculation part 132 calculates the phase shifts when the antenna device 110 receives signals of ch1, ch2, ch3, and ch4 from the smartphone 50. To illustrate a more specific example, when the four pairs of antenna elements in the antenna device 110 receive the ch1, ch2, ch3, and ch4 signals from the smartphone 50, the standard deviation calculation part 132 calculates phase shifts in each pair.

Using the antenna element 1 at the center as a common antenna element, the four pairs of antenna elements of the antenna device 110 are: the antenna elements 1 and 2; the antenna elements 1 and 3; the antenna elements 1 and 4; and the antenna elements 1 and 5.

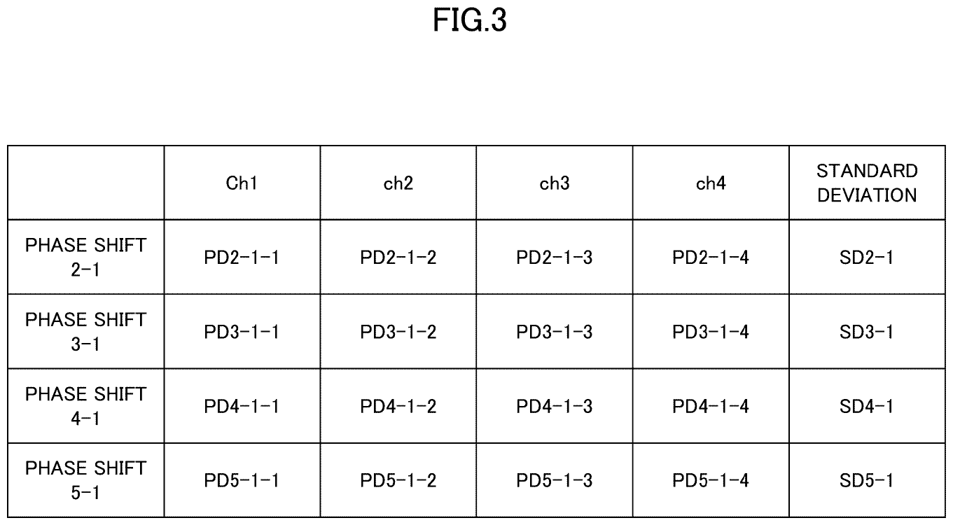

As shown by the table of FIG. 3, upon receipt of the signals of four frequencies from the smartphone 50, the four pairs of antenna elements show the following phase shifts per channel: a phase shift 2-1, obtained by subtracting the phase of a signal received at the antenna element 1 from the phase of a signal received at the antenna element 2; a phase shift 3-1, obtained by subtracting the phase of a signal received at the antenna element 1 from the phase of a signal received at the antenna element 3; a phase shift 4-1, obtained by subtracting the phase of a signal received at the antenna element 1 from the phase of a signal received at the antenna element 4; and a phase shift 5-1, obtained by subtracting the phase of a signal received at the antenna element 1 from the phase of a signal received at the antenna element 5. That is, as shown in FIG. 3, the standard deviation calculation part 132 calculates the phase shift 2-1, phase shift 3-1, phase shift 4-1, and phase shift 5-1 for all of ch1, ch2, ch3, and ch4. In FIG. 3, for example, the phase shift 2-1 for ch1, the phase shift 2-1 for ch2, the phase shift 2-1 for ch3, and the phase shift 2-1 for ch4 are shown as “PD2-1-1,” “PD2-1-2,” “PD2-1-3,” and “PD2-1-4,” respectively. The same applies to the phase shift 3-1, the phase shift 4-1, and the phase shift 5-1.

When all the phase shifts 2-1, phase shifts 3-1, phase shifts 4-1, and phase shifts 5-1 are determined, the standard deviation calculation part 132 calculates the standard deviation of phase shifts on each of ch1, ch2, ch3, and ch4. In FIG. 3, the standard deviation of the phase shifts 2-1, the standard deviation of the phase shifts 3-1, the standard deviation of the phase shifts 4-1, and the standard deviation of the phase shifts 5-1 are shown as “SD2-1”, “SD3-1”, “SD4-1”, and “SD5-1”, respectively.

The selection part 133 selects the pair where the minimum standard deviation of phase shifts is calculated by the standard deviation calculation part 132. Furthermore, from among the two antenna elements included in the selected pair, the selection part 133 selects the antenna element that is not the antenna element 1. The fact that a pair of antenna elements has the minimum standard deviation of phase shifts among the four pairs means that the pair is least affected by multi-path and that the quality of phase shifts at the pair is therefore the highest among the four pairs. Here, “the quality of phase shifts” at a pair of antenna elements refers to how little the pair is affected by multi-path; and phase shifts of good quality lead to more accurate distance measurement. Selecting the pair of antenna elements with the minimum standard deviation of phase shifts among four pairs of antenna elements is an example of selecting a pair of antenna elements where the quality of phase shifts is higher than or equal to a predetermined level.

Note that, although an example of selecting one pair of antenna elements showing the minimum standard deviation of phase shifts among multiple pairs will be described here, the method of selecting a pair where the quality of phase shifts is higher than or equal to a predetermined level is not limited to this. For example, a pair of antenna elements where the standard deviation of phase shifts is less than or equal to a predetermined threshold may be selected from multiple pairs. In the event a number of pairs of antenna elements show standard deviations of phase shifts that are less than or equal to a predetermined threshold, for example, the pair showing the minimum standard deviation of phase shifts may be selected. Selecting a pair of antenna elements where the standard deviation of phase shifts is less than or equal to a predetermined threshold is another example of selecting a pair where the quality of phase shifts is higher than or equal to a predetermined level.

The azimuth calculation part 134 calculates an azimuth, which indicates the location of the smartphone 50, based on signals extracted by the communication part 120 from the modulated signals received by the antenna elements 1 to 5. The calculation method will be described in detail later.

The azimuth calculation part 134 calculates the azimuth of the smartphone 50 relative to the antenna device 110 using the pair selected by the selection part 133 (the pair with the minimum standard deviation of phase shifts) and one of the remaining three pairs. When the pair selected by the selection part 133 includes the antenna element 2 or 4 (the second antenna element), the pair to be selected from among the three remaining pairs is the pair where the standard deviation of phase shifts calculated by the standard deviation calculation part 132 is smaller between the two pairs including the antenna element 3 or 5 (the third antenna element). Likewise, when the pair selected by the selection part 133 includes the antenna element 3 or 5 (the third antenna element), the pair to be selected from among the three remaining pairs is the pair where the standard deviation of phase shifts calculated by the standard deviation calculation part 132 is smaller between the two pairs including the antenna element 2 or 4 (the second antenna element).

The azimuth calculation part 134 calculates the azimuth using the pair of the first antenna element and the second antenna element and the pair of the first antenna element and the third antenna element. In other words, using one first antenna element, one second antenna element, and one third antenna element, the azimuth calculation part 134 calculates the azimuth from the ratio of: a first phase shift, which is the phase shift between signals received by the pair of the first antenna element and the second antenna element in a first axis direction; and a second phase shift, which is the phase shift between signals received by the pair of the first antenna element and the third antenna element. The distance between the first antenna element and the second antenna element in the first axis direction (an example of a predetermined distance) and the distance between the first antenna element and the third antenna element in the second axis direction (another example of a predetermined distance) are equal.

The elevation angle calculation part 135 calculates an elevation angle, which indicates the location of the smartphone 50, based on the azimuth calculated by the azimuth calculation part 134 and the first phase shift or the second phase shift. The calculation method will be described in detail later.

Using one of the two antenna elements included in the pair selected by the selection part 133 (the pair with the minimum standard deviation of phase shifts), the distance measurement part 136 measures the distance between the antenna device 110 and the smartphone 50 based on the phases of signals communicated between this antenna element and the smartphone 50. The one antenna element to be selected from among the two antenna elements included in the pair selected by the selection part 133 is the antenna element that is not the first antenna element and is the second antenna element or the third antenna element. For example, if the selection part 133 selects the pair including the two antenna elements 1 and 2, the antenna element 2 is the antenna element for measuring the distance to the smartphone 50. Likewise, if the selection part 133 selects the pair including the two antenna elements 1 and 3, the antenna element 3 is the antenna element for measuring the distance to the smartphone 50. The antenna element 1 can also be used to measure the distance to the smartphone 50. However, the antenna element 1 serves as a reference point in the calculation of phase shifts and is not subject to evaluation. Consequently, one of the antenna elements 2 to 5, which are all subject to evaluation, is used to measure the distance to the smartphone 50. The antenna element that the distance measurement part 136 uses thus in distance measurement is referred to as the “TOA antenna element”.

The distance measurement part 136 transmits signals of the frequencies ch1 to ch4 from the TOA antenna element to the smartphone 50, and receives signals of the frequencies ch1 to ch4 from the smartphone 50 via the TOA antenna element. The distance measurement part 136 obtains data indicating the phases of the signals of these frequencies as received at the smartphone 50, from the smartphone 50, via BLE communication or the like.

The distance measurement part 136 calculates the sum of the phase of a signal of one frequency as received at the TOA antenna element and the phase of a signal of the frequency as received at the smartphone 50. The distance measurement part 136 calculates this sum, or the “roundtrip phase”, for all of the four frequencies. Based on the relationship between multiple frequencies and the roundtrip phase at each frequency, the distance between the antenna device 110 and the smartphone 50 is measured.

The memory 137 stores programs and data that the standard deviation calculation part 132, the selection part 133, the azimuth calculation part 134, the elevation angle calculation part 135, and the distance measurement part 136 need when executing the processes described hereinabove and the processes that will be described hereinbelow.

Next, the method of calculating the azimuth and elevation angle will be described. The interval between the antenna elements 1 and 2 (the interval between their respective centers) in the X direction is dx. The interval between the antenna elements 1 and 4 in the X direction is also dx. The interval between the antenna elements 1 and 3 (the interval between their respective centers) in the Y direction is dy. The interval between the antenna elements 1 and 5 in the Y direction is also dy.

If the phase shift between signals received by the first antenna element and the second antenna element is βx, the phase shift between signals received by the first antenna element and the third antenna element is βy, and the wavelength of the signals is λ, the phase shifts βx and βy can be expressed by the following mathematical expressions 1 and 2. The phase shift βx is an example of the first phase shift, and the phase shift βy is an example of the second phase shift.

$$[ Mathematical Expression 1 ]$$

$${β}_{x} = \frac{2 π}{λ} {d}_{x} cos ϕ sin θ \qquad ( 1 )$$

$$[ Mathematical Expression 2 ]$$

$${β}_{y} = \frac{2 π}{λ} {d}_{y} sin ϕ sin θ \qquad ( 2 )$$

By combining the mathematical expressions 1 and 2 with the azimuth φ and the elevation angle θ, the following mathematical expressions 3 to 6 are given:

$$[ Mathematical Expression 3 ]$$

$$θ = {sin}^{- 1} ( \frac{{β}_{x}}{2 π} \cdot \frac{λ}{{d}_{x}} \cdot \frac{1}{cos ϕ} ) \qquad ( 3 )$$

$$[ Mathematical Expression 4 ]$$

$$ϕ = {cos}^{- 1} ( \frac{{β}_{x}}{2 π} \cdot \frac{λ}{{d}_{x}} \cdot \frac{1}{sin θ} ) \qquad ( 4 )$$

$$[ Mathematical Expression 5 ]$$

$$θ = {sin}^{- 1} ( \frac{{β}_{y}}{2 π} \cdot \frac{λ}{{d}_{y}} \cdot \frac{1}{sin ϕ} ) \qquad ( 5 )$$

$$[ Mathematical Expression 6 ]$$

$$ϕ = {sin}^{- 1} ( \frac{{β}_{y}}{2 π} \cdot \frac{λ}{{d}_{y}} \cdot \frac{1}{sin θ} ) \qquad ( 6 )$$

Given the mathematical expressions 1 and 2, the ratio of βy to βx can be expressed by the following mathematical expression 7.

$$[ Mathematical Expression 7 ]$$

$$\frac{{β}_{y}}{{β}_{x}} = \frac{\frac{2 π}{λ} {d}_{y} sin ϕ sin θ}{\frac{2 π}{λ} {d}_{x} cos ϕ sin θ} \qquad ( 7 )$$

Since dx=dy holds here, the mathematical expression 7 gives the following mathematical expression 8, which can be further rearranged to the following mathematical expression 9, so that the azimuth φ can be determined.

$$[ Mathematical Expression 8 ]$$

$$\frac{{β}_{y}}{{β}_{x}} = \frac{sin ϕ}{cos ϕ} = tan ϕ \qquad ( 8 )$$

$$[ Mathematical Expression 9 ]$$

$$ϕ = {tan}^{- 1} ( \frac{{β}_{y}}{{β}_{x}} ) \qquad ( 9 )$$

By using the azimuth φ calculated based on the mathematical expression 9, the elevation angle θ can be determined from either the mathematical expression 3 or the mathematical expression 5. When calculating the elevation angle θ from the mathematical expression 3, the phase shift βx may be used. When calculating the elevation angle θ from the mathematical expression 5, the phase shift βy may be used.

### Flowchart

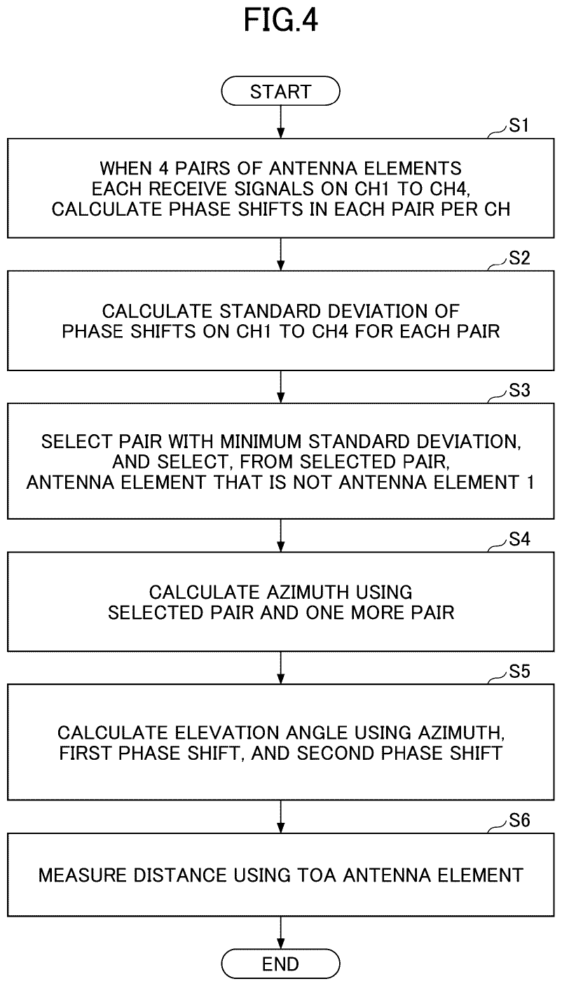

FIG. 4 is a flowchart showing examples of steps to be executed by the control device 130.

When the process is started, the four pairs of antenna elements in the antenna device 110 each receive signals of ch1 to ch4 from the smartphone 50, and, upon the signals' receipt, the standard deviation calculation part 132 calculates the phase shifts in each pair, per channel/frequency (that is, calculates phase shifts 2-1, phase shifts 3-1, phase shifts 4-1, and phase shifts 5-1 per channel/frequency) (step S1). The basic premise of step S1 is that the main control part 131 communicates with the smartphone 50 and controls the smartphone 50 to transmit the signals of ch1 to ch4, and that the signals are received by the antenna device 110, and the signals' phases upon receipt are stored in the memory 137. In step S1, the standard deviation calculation part 132 reads the data of the respective phases of the signals of ch1 to ch4 as received by the four pairs of antenna elements, from the memory 137, and calculates the phase shifts in each pair.

For each of the phase shifts 2-1, the phase shifts 3-1, the phase shifts 4-1, and the phase shifts 5-1, the standard deviation calculation part 132 calculates the standard deviation of phase shifts on ch1, ch2, ch3, and ch4 (that is, calculates SD2-1, SD3-1, SD4-1, and SD5-1) (step S2).

The selection part 133 selects the pair where the minimum standard deviation of phase shifts is calculated by the standard deviation calculation part 132. Furthermore, from among the two antenna elements included in the selected pair, the selection part 133 selects the antenna element that is not the antenna element 1 (step S3).

Using the pair selected by the selection part 133 and one more pair among the remaining three pairs, the azimuth calculation part 134 calculates the azimuth of the smartphone 50 relative to the antenna device 110 (step S4).

The elevation angle calculation part 135 calculates an elevation angle, which indicates the location of the smartphone 50, based on the azimuth calculated by the azimuth calculation part 134 and one of the first phase shift and the second phase shift (step S5).

Using the antenna element (TOA antenna element) that is not the antenna element 1 among the two antenna elements included in the pair selected by the selection part 133 in step S3, the distance measurement part 136 measures the distance between the antenna device 110 and the smartphone 50 (step S6).

This completes the series of processes (END).

### Advantages

The positioning device 100 includes: an antenna device 110 with N antenna elements including antenna elements forming multiple pairs, where N is an integer of 3 or greater; a selection part 133 that, when the multiple pairs of antenna elements receive signals from a positioning target device (for example, a smartphone 50), selects a pair of antenna elements where the quality of phase shifts is higher than or equal to a predetermined level, based on phase shifts determined for the phases of the signals as received by the antenna elements of each pair; a distance measurement part 136 that measures the distance between the antenna device 110 and the positioning target device based on the phases of the signals communicated between one antenna element in the pair selected by the selection part 133 and the positioning target device. Consequently, the distance can be measured using one of the two antenna elements included in a pair where the quality of phase shifts is higher than or equal to a predetermined level. A pair where the quality of phase shifts is higher than or equal to a predetermined level is a pair that is affected little by multi-path.

Therefore, it is possible to provide a positioning device 100 that can calculate a highly accurate distance measurement result quickly.

Furthermore, the selection part 133 includes an angle calculation part (for example, an azimuth calculation part 134 and an elevation angle calculation part 135) that calculates an angle that indicates the direction in which the positioning target device (one example is a smartphone 50) is located, relative to the antenna device 110, based on the phase shift between the phases of signals that at least one pair of antenna elements among the multiple pairs receive from the positioning target device. It is therefore possible to provide a positioning device 100 that can calculate a highly accurate distance measurement result quickly and that can calculate the angles (for example, the azimuth and the elevation angle) of the positioning target device relative to the antenna device 110. Also, by using the pair selected by the selection part 133 to calculate these angles, accurate angles can be calculated.

Also, the N antenna elements include multiple antenna elements positioned at equal intervals along a first axis and a second axis. The angle calculation part (for example, the azimuth calculation part 134) calculates the azimuth of the positioning target device relative to the antenna device 110 based on the ratio of: a first phase shift between the phases of signals that one first antenna element among the multiple antenna elements and a second antenna element located at a predetermined distance from the first antenna element in the first axis direction receive from the positioning target device; and a second phase shift between the phases of signals that the one first antenna element among the multiple antenna elements and a third antenna element located at a predetermined distance from the first antenna element in the second axis direction receive from the positioning target device (for example, the smartphone 50). As a result of this, the positioning device 100 can calculate a highly accurate distance measurement result quickly and calculate the azimuth of the positioning target device relative to the antenna device 110 using the first antenna element, the second antenna element, and the third antenna element.

Also, the angle calculation part (for example, the elevation angle calculation part 135) calculates the elevation angle of the positioning target device (for example, the smartphone 50) relative to the antenna device 110 based on the azimuth and the first phase shift or the second phase shift. As a result of this, the positioning device 100 can calculate a highly accurate distance measurement result quickly and calculate the elevation angle of the positioning target device relative to the antenna device 110 using the azimuth and the first phase shift or the second phase shift.

Also, when the antenna elements of each pair among the multiple pairs receive signals of multiple frequencies from the positioning target device (for example, a smartphone 50), the selection part 133 determines the standard deviations of multiple phase shifts between phases at multiple frequencies, and selects, from among the multiple pairs of antenna elements, a pair of antenna elements where the quality of standard deviation is higher than or equal to a predetermined level. Therefore, a pair of antenna elements where the quality of phase shifts is higher than or equal to a predetermined level can be selected based on the standard deviations of phase shifts in the multiple pairs of antenna elements. Consequently, the positioning device 100 can calculate a highly accurate distance measurement result quickly using a pair of antenna elements, which has a quality of phase shifts higher than or equal to a predetermined level, and which is selected based on the standard deviations of phase shifts in the multiple pairs of antenna elements.

Also, the selection part 133 selects, from among the multiple pairs of antenna elements, the pair of antenna elements showing the minimum standard deviation or a pair of antenna elements showing a standard deviation less than or equal to a predetermined threshold. It is thus possible to select one pair of antenna elements that shows the minimum standard deviation or a standard deviation less than or equal to a predetermined threshold and that shows a quality of phase shifts higher than or equal to a predetermined level. Therefore, it is possible to provide a positioning device 100 that can calculate a highly accurate distance measurement result quickly using one pair of antenna elements that shows the minimum standard deviation or a standard deviation less than or equal to a predetermined threshold and that shows a quality of phase shifts that is higher than or equal to a predetermined level.

Note that, although an embodiment in which the azimuth calculation part 134 and the elevation angle calculation part 135 of the control device 130 calculate the azimuth and the elevation angle, and the distance measurement part 136 measures the distance, has been described above, it is equally possible to employ a structure in which the control device 130 does not have the azimuth calculation part 134 and the elevation angle calculation part 135, and the distance measurement part 136 measures the distance.

Although a positioning device according to an exemplary embodiment of the present disclosure has been described above, the present disclosure is by no means limited to the specifics of the embodiment disclosed herein, and various modifications and changes are possible without departing from the scope of the accompanying claims.

What is claimed is:

1. A positioning device comprising:
an antenna part with N antenna elements from which combinations of two antenna elements are selected to form a plurality of pairs, N being an integer greater than or equal to three;
a selection part configured to select a pair of antenna elements whose phase shift quality is higher than or equal to a predetermined level, based on a phase shift observed between phases of a signal received by respective antenna elements in a pair when each of the plurality of pairs receives the signal from a positioning target device; and
a distance measurement part configured to measure a distance between the positioning target device and the antenna part based on phases of signals communicated between the positioning target device and one antenna element included in the pair of antenna elements selected by the selection part,
wherein the selection part is configured to determine, for each of the plurality of pairs, a standard deviation of phase shifts, each of which is observed between phases of a corresponding one of a plurality of signals having respective frequencies received from the positioning target device, and the selected pair of antenna elements is a pair whose standard deviation has a quality higher than or equal to a predetermined level, and
wherein the signals having respective frequencies are signals having different frequencies.

2. The positioning device according to claim 1, further comprising an angle calculation part configured to calculate an angle that indicates a direction in which the positioning target device is located relative to the antenna part, based on a phase shift between phases of a signal received by at least one of the plurality of pairs from the positioning target device.

3. The positioning device according to claim 2,
wherein the N antenna elements include a plurality of antenna elements that are positioned at equal intervals along a first axis and a second axis, and
wherein the angle calculation part is further configured to calculate an azimuth of the positioning target device relative to the antenna part, based on a ratio of:
a first phase shift observed between phases of a signal received by a first antenna element and a second antenna element among the plurality of antenna elements from the positioning target device, the second antenna element being located at a predetermined distance from the first antenna element in a direction of the first axis; and
a second phase shift observed between phases of a signal received by the first antenna element and a third antenna element among the plurality of antenna elements from the positioning target device, the third antenna element being located at the predetermined distance from the first antenna element in a direction of the second axis.

4. The positioning device according to claim 3, wherein the angle calculation part is further configured to calculate an elevation angle of the positioning target device relative to the antenna part based on the azimuth and either the first phase shift or the second phase shift.

5. The positioning device according to claim 4, wherein the selection part is further configured such that the selected pair of antenna elements is a pair whose standard deviation is smallest among the plurality of pairs, or a pair whose standard deviation is less than or equal to a predetermined threshold.
